(19) United States
(12) Patent Application Publication
(10) Pub. No.: US 2013/0192530 A1
(43) Pub. Date: Aug. 1, 2013

(54) PET LITTER BOX EMPLOYING ULTRAVIOLET IRRADIATION AND REFLECTIVE INTERIOR

(71) Applicant: Stewart Jeffrey LOVENVIRTH, Hallandale, FL (US)

(72) Inventor: Stewart Jeffrey LOVENVIRTH, Hallandale, FL (US)

(21) Appl. No.: 13/362,390

(22) Filed: Jan. 31, 2012

(51) Int. Cl. A01K 29/00

(52) U.S. Cl. 119/163; 119/165; 119/171

(57) ABSTRACT

A litter box for pets is provided having a container defined by a bottom and side walls and a germicidal ultraviolet light lamp positioned parallel to the bottom of the container and around the interior peripheral edge of the container, whereby the light from the lamp has an unobstructed path to the absorbent granular material in the container. The interior surface of the container is reflective to maximize the incident UV light treating the granular material. A motion detector may be provided to turn the lamp off and on when a pet approaches the litter box.

The present invention is directed towards a litter box for pets, which employs ultraviolet germicidal irradiation to reduce potentially harmful microorganisms and includes a UV light reflective liner.

### BACKGROUND OF THE INVENTION

It is known that ultraviolet light of sufficiently short wavelength can be used to kill microorganisms. The ultraviolet light has a mutagenic effect on a microorganism's DNA, preventing reproduction and killing the microorganism. Ultraviolet light having a wavelength of 240-280 nm, also known as UV-C, appears to have the greatest germicidal properties.

Ball, U.S. Pat. No. 4,998,504 discloses a disposable pet litter box having a transparent container disposed within a sanitizing support container. Cat litter is placed in the transparent container. The support container has ultraviolet light producing lamps around its interior. The lamps, however, are exterior to the transparent container containing the litter. The UV light is transmitted though the transparent container and penetrates into the cat litter, to kill microorganisms.

Gantt, U.S. Pat. No. 6,857,391 discloses an animal toilet enclosure. The enclosure has floorboards arranged similar to louvers, which pivot to an open position, after the toilet has been used, to deposit the contents into a disposal hopper. Overhead ultraviolet and heat lamps may be provided in the enclosure to semi-sterilize and dry the floorboards.

Mottard, U.S. Pat. No. 7,490,578 discloses a container having a roof, with a UV light source mounted on the roof. The device is designed so that no UV light is directed at the opening of the container.

The prior art devices suffer from various drawbacks, including lack of simplicity, high cost, and attenuation of the intensity of the ultraviolet light caused by transmission through plastic walls or the relative distance between the light source and material to be treated. Thus, there remains a need for an uncomplicated, inexpensive and effective method of treating litter boxes, to reduce potentially harmful microorganisms.

### SUMMARY OF THE INVENTION

A litter box for pets, especially cats, is provided, having a germicidal, ultraviolet light producing lamp to kill microorganisms in the litter. The litter box includes a container having a bottom and side walls. The upper edges of the side walls define a periphery of the container. The shape of the container may be rectangular, circular or other geometry. Typically, the container is provided with a flat bottom, for stability. The side walls need not be the same height around the periphery of the container. For example, the side walls may be relatively high in most places, to prevent the litter from being thrown out, and be provided with a cut-out or notch, to allow a pet to easily enter and exit the interior of the container.

The container may be open from above. Alternatively, the container may be fitted with a domed cover, to reduce odor. The containers commonly used for pet litter boxes are opaque, for aesthetics and to minimize cost. By way of example, the sides of the litter box may range in height from 3 to 12 inches.

The litter box includes a source of germicidal, ultraviolet irradiation, such as a germicidal lamp that produces ultraviolet light (UV-C) having a wavelength of from 240-280 nm and with sufficient intensity to kill microorganisms exposed to the irradiation. By way of example, the lamp may be a low pressure or medium pressure lamp, as are known in the art.

The litter box is provided with means to support the UV-C lamp in a position parallel to the bottom of the container and along the side of the container, with a line-of-sight path to the upper surface of an absorbent granular material filled to a height of 4 inches, in the interior of the container. The ultraviolet lamp is positioned relative to the container so that the line-of-sight path between the lamp and the upper surface of the absorbent granular material in the container is “unobstructed,” that is, the ultraviolet light does not pass through the container itself, before reaching the absorbent granular material.

The germicidal ultraviolet light producing lamp may extend along one or more sides of the container. For example, the lamp may extend along one, two, three or four walls of a rectangular container. In another embodiment of the invention, multiple sources of germicidal ultraviolet irradiation or lamps may be provided, which can be positioned along two sides of the container, for example on opposite sides, or along all sides of the container.

One means to support the germicidal ultraviolet lamp is a rim that engages the upper periphery of the container. For ease of cleaning, the rim may be detachable. Alternatively, the means for supporting the lamp may be clips that connect that lamp to the upper periphery of the container.

The litter box may be filled with an absorbent granular material, such a clay or sand, as is well known. Typically, the container is filled to a level of 2 to 4 inches with the absorbent material. The lamp may be positioned from 3 to 12 inches from the bottom of the container, in particular from 4 to 10 inches from the bottom of the container, to optimize the light intensity and area covered.

In one embodiment of the invention, the litter box is provided with a motion detector, which activates a switch to turn off the lamp, when a pet is in close proximity to the litter box. Disengaging the germicidal ultraviolet lamp when the pet approaches or enters the interior of the container is desirable both for pet safety and to avoid alarming the pet. By way of example the motion detector may be a passive infrared (PIR), ultrasonic or microwave based detector.

The interior surface of litter box may be made of a material that is highly reflective to UV light. A material is considered to be highly reflective if it reflects at least 80%, preferably at least 90% of the UV light. In one embodiment of the invention, a removable, reflective liner is inserted between the inside surface of the litter box and the absorbent granular material. The liner may be a metalized film in the shape of a traditional litter box liner, which is highly reflective to the UV light, and can be economically replaced when the litter is changed. The reflective interior surface of the litter box or reflective liner significantly increases the incident UV light treating the contents of the litter box.

### BRIEF DESCRIPTION OF THE DRAWINGS

FIG. 1 is a perspective view of the pet litter box.

FIG. 2 is an exploded view of the pet litter box.

FIG. 3 is a perspective view of an embodiment of the invention in which the ultraviolet lamp may clip on to the side of the pet litter box.

FIG. 4 is a perspective view of the pet litter box, with a replaceable, reflective liner, which is secured by a detachable rim.

### DETAILED DESCRIPTION OF THE INVENTION

Without intending to limit the scope of the invention, the preferred embodiments and features are hereinafter set forth. All United States patents cited in the specification are incorporated herein by reference.

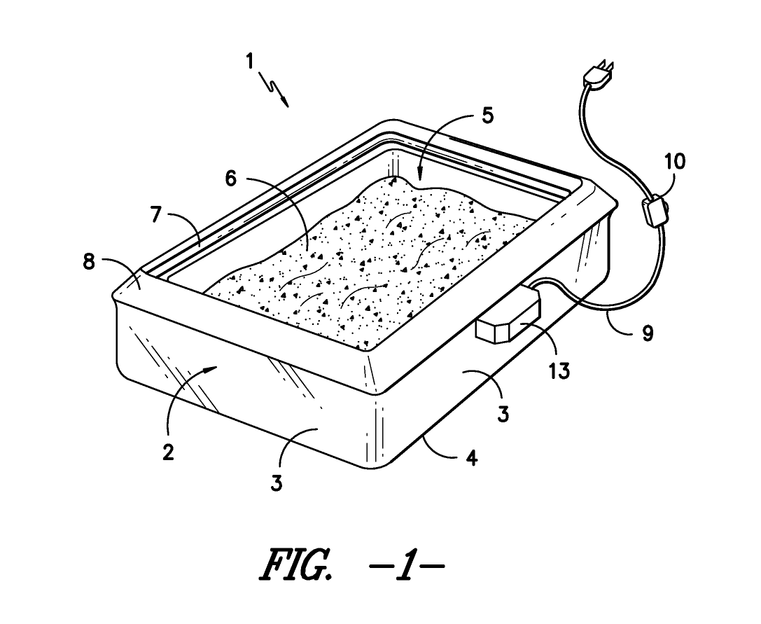

Referring to FIG. 1, pet litter box 1 includes container 2 having side walls 3 and bottom 4. Container 2 is rectangular in shape, but can be provided in other geometries. Side walls 3 and bottom 4 define an interior 5, which contains an absorbent granular material 6.

An ultraviolet light producing lamp 7 is positioned along the upper peripheral edge of container 2, whereby lamp 7 is parallel to bottom 4 and extends along the interior of side walls 3. Means are provided to support lamp 7 in a position with an unobstructed, line-of-sight path to interior 5 of container 2 and the upper surface of absorbent granular material 6.

An electrical power cord 9, with on/off switch 10 is provided for lamp 7. Lamp 7 includes the components necessary to generate ultraviolet light having germicidal properties from an electric current, such as a ballast for triggering ionization and controlling the current. A side wall 3 of container 2 may be provided with a cavity, accessible from the exterior, for storing electrical cord 9 or portion thereof.

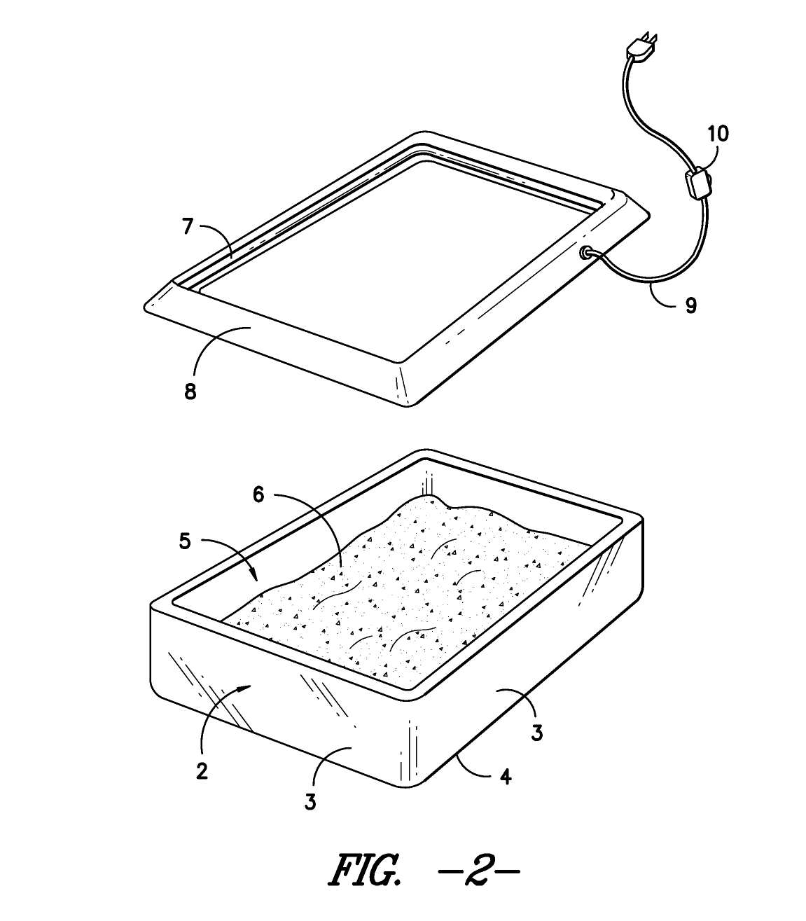

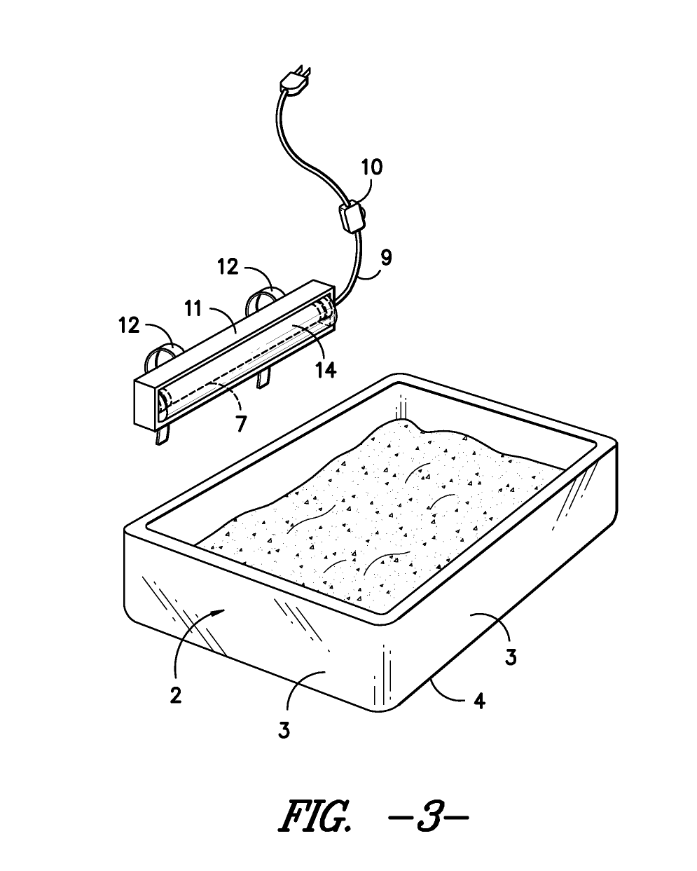

In one embodiment of the invention, the means to support lamp 7 is detachable rim 8, which houses lamp 7. Referring to FIG. 2, an illustration of rim 8 lifted from container 2 is shown. In an alternative embodiment of the invention shown in FIG. 3, the means to support lamp 7 is fixture 11, having brackets 12 for engaging the sides 3 of container 2. Additionally, as shown in FIG. 3, a cover 14 may be provided over lamp 7, to protect the lamp, as well as to protect a pet from electrical shock. Cover 14 should be selected from materials with maximum transmission of ultraviolet light in the germicidal wavelength (240-280 nm), such as fused silica quartz glass.

It can be understood that lamp 7 and the means to support lamp 7 in the desired position on container 2 may be provided separately, that is, as an after-market product to be added to a container. For example, rim 8, including lamp 7 and power cord 9, may be sold separately to be used with a suitably dimensioned container. Alternatively, fixture 11, lamp 7 and power cord 9, shown in FIG. 3, may be provided separately.

Referring to FIG. 1, lamp 7 is shown extending around the perimeter of container 2, in particular, along all four sides of the container. Other deployments of a single lamp or multiple lamps may be used, preferably around the interior of the side walls 3 or upper peripheral edges of the side walls 3 of container 2. For example, a single lamp 7 may be deployed along one, two or three sides of a rectangular container or partially around the perimeter of a container. Alternatively, multiple lamps may be deployed on two or more sides of container 2. For example, two lamps, such as the arrangement shown in FIG. 3, may be deployed on opposite sides of container 2.

Container 2 and rim 8, where applicable, may be made from a thermoplastic, thermosetting or elastomeric polymer, as is known to those skilled in the art. One method of manufacturing the parts is to inject mold a thermoplastic polymer resin. Alternatively, container 2 and/or rim 8 may be metal, such as sheet metal. By way of example, container 2 and/or rim 8 may be made of a reflective metal, such as aluminum or polished steel, to maximize the reflection of the ultraviolet light, thereby increasing the intensity and distribution of the light. Preferably, rim 8 is opaque.

In another embodiment of the invention, a removable, reflective liner is inserted inside container 2, positioned between the interior of sides 3 and granular material 6. The liner could be a band that is positioned along sides 3, for example, extending from the bottom 4 to the upper peripheral edge of container 2. Alternatively, the liner may be continuous and cover the interior surface of container 2, including bottom 4. The liner may be virtually any material that is highly reflective to UV light, such as a metal, for example polished aluminum or stainless steel. The liner may be formed from a sheet or film of metal and can range from being rigid to flexible. In one example, the reflective liner may be in the shape of a rectangular pan having a polished metal interior surface.

The liner may be a metalized film. Typically, such films are made by vapor deposition of a reflective metal, such as aluminum, on a polymer film, such as a polyester film, in particular polyethylene terephthalate, a polyolefin film, in particular oriented polypropylene, or a polyamide film, such as nylon. The metalized film may be in the shape of a disposable liner that is inserted between the inside of container 2 and granular material 6, and is dimensioned to fold over the upper peripheral edge of container 2. The advantage of metalized film liners relative to conventional, non-metalized polymer film litter box liners, is that the metalized film is less permeable to fluids and is tougher, that is, it has greater resistance to punctures and tears.

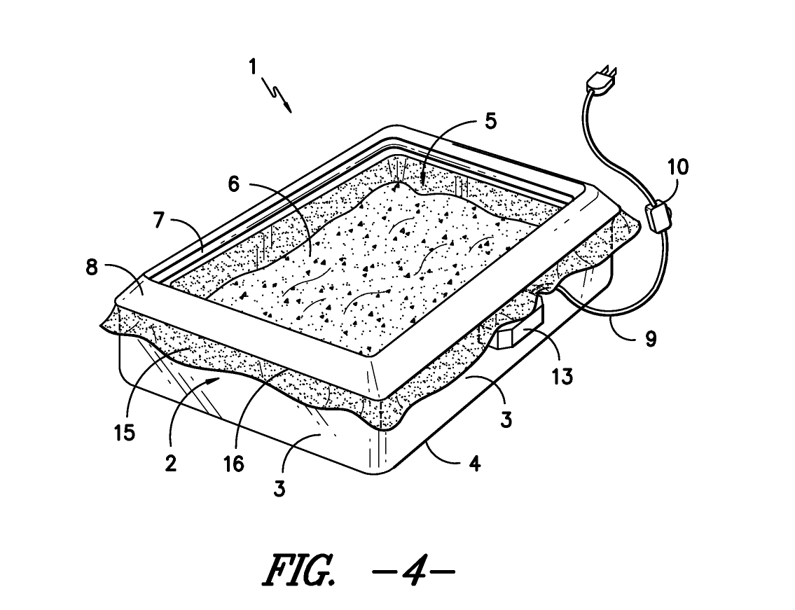

An example of a removable, reflective liner is shown in FIG. 4. Metalized film 15 overlaps the upper peripheral edge 16 and is held in place by rim 8. In the embodiment shown in FIG. 4, rim 8 functions to both secure the flexible, reflective liner and support lamp 7.

Referring to FIG. 1, ultraviolet light lamp 7 may optionally be controlled by motion detector 13. When a pet approaches the box, the motion detector will turn off the lamp, which has the advantages of protecting the pet from the potentially harmful ultraviolet light and avoiding alarming the pet. The motion detector can be set to turn back on the lamp, after a certain period of time, for example, ten minutes.

In an alternative embodiment of the invention, the motion detector may be set to turn on the lamp, a certain time after the approach of a pet is detected, and then to automatically turn off the lamp after a certain period of treatment time. For example, in one scenario, ten minutes after the motion detector senses the approach of the pet and presumably after the pet has used the litter box, the lamp is turned on for one hour, to sterilize the absorbent granular material.

The lamp of the subject invention may also be used in combination with various timing devices, to conserve electricity, as is known to those skilled in the art. For example, the lamp may be made to cycle on and off throughout the day. The invention may be further understood by reference to the following claims.

What I claim is:

1. A litter box for pets, comprising:
(a) a container having an interior defined by a bottom and side walls;
(b) a liner positioned in the interior of the container, wherein the liner has side walls and the liner side walls have a highly reflective interior face aligned parallel to the container side walls;
(c) a germicidal ultraviolet light producing lamp; and
(d) means to support the lamp in a position parallel to the bottom of the container, wherein the lamp is positioned to provide an unobstructed, line-of-sight path for the ultraviolet light to the interior of the container.

2. The litter box of claim 1, wherein the liner is continuous and overlays the bottom and side walls of the container.

3. The litter box of claim 2, wherein the liner is selected from the group consisting of metal sheets, metal films and metalized polymer films.

4. The litter box of claim 3, wherein the liner is a metalized polymer film.

5. The litter box of claim 4, wherein the means to support the lamp is a detachable rim, which engages a periphery of the container.

6. The litter box of claim 5, wherein the liner extends past the periphery of the container and is held in place by the rim.

7. The litter box of claim 3, wherein the metalized polymer film is comprised of aluminum that is vapor deposited on polyester or polyolefin film.

8. The litter box of claim 2, wherein the lamp is positioned between 3 inches and 12 inches from the bottom of the container.

9. The litter box of claim 1, wherein the litter box further comprises an absorbent, granular material.

10. The litter box of claim 1, wherein the container is opaque.

11. A litter box for pets, comprising:
(a) a container having an interior defined by a bottom and side walls, wherein each of the side walls has an interior and exterior face, and wherein the interior face of the side walls is a highly reflective surface;
(b) a germicidal ultraviolet light producing lamp; and
(c) means to support the lamp in a position parallel to the bottom of the container and along an interior face of a side wall of the container, wherein the lamp is positioned to provide an unobstructed, line-of-sight path for the ultraviolet light to the interior of the container.

12. The litter box of claim 11, wherein the container is rectangular and the lamp extends along the interior face of at least two side walls.

13. The litter box of claim 12, wherein the lamp extends along the interior face of all of the side walls.

14. The litter box of claim 11, wherein the lamp is positioned between 4 inches and 10 inches from the bottom of the container.

15. The litter box of claim 11, wherein the container is metal selected from the group consisting of aluminum and steel.

16. The litter box of claim 11, further comprising a motion detector to control the lamp whereby the lamp is turned off when a pet is in close proximity to the container.

17. The litter box of claim 11, wherein the reflective surface of the side walls of the container is a metalized polymer film overlaying the side walls.

18. The litter box of claim 17, wherein the means to support the lamp is a detachable rim, which engages a periphery of the container.

19. The litter box of claim 18, wherein the metalized polymer film extends past the periphery of the container and is held in place by the rim.

20. The litter box of claim 19, wherein the lamp extends along the interior face of all of the side walls and the lamp is positioned between 3 inches and 12 inches from the bottom of the container.
